(19) United States
(12) Patent Application Publication
(10) Pub. No.: US 2007/0177384 A1
(43) Pub. Date: Aug. 2, 2007

(54) Motion sensing lighting fixture

(75) Inventors: Gregory L. Sibalich, Bowling Green, KY (US); Chik Kin Wing Ricky, Tuen Mun (HK)

Correspondence Address: MIDDLETON & REUTLINGER, 2500 BROWN & WILLIAMSON TOWER, LOUISVILLE, KY, 40202, US

(73) Assignee: Desa IP, LLC, a Florida limited liability company, Miami, FL (US)

(21) Appl. No.: 11/345,831

(22) Filed: Feb. 2, 2006

(51) Int. Cl. F21V 23/04

(52) U.S. Cl. 362/276

(57) ABSTRACT

The present invention relates to a lighting fixture housing a motion sensor. More specifically, the invention relates to a lighting fixture and motion sensor completely integrated with a support post or a pedestal. The lighting fixture houses a motion sensor with greater than 180-degree motion sensing capabilities. In accordance with one embodiment of the present invention, the fixture comprises an internal assembly and a protective assembly. The protective assembly comprises an enclosure covering a housing structure. The internal assembly is situated completely within the protective assembly. The one or more lens shields can be used to cover the housing windows through which infrared radiation passes to the internal assembly, and the lens shields may act as a filter that can be used to customize the field of view of the sensor by screening or blocking radiation coming from selected angles. The fixture can be completely integrated with either a post or pedestal in a manner that is aesthetically pleasing.

### CROSS-REFERENCE TO RELATED APPLICATIONS

Not applicable

### BACKGROUND OF THE INVENTION

1. Field of the Invention

The present invention relates to a lighting fixture housing a motion sensor with greater than 180-degree motion sensing capabilities. More specifically, the invention relates to such a lighting fixture and motion sensor completely integrated with a support post or pedestal mount.

2. Description of Related Art

Passive infrared sensors (PIRs) are electronic devices that are used in lighting and security systems to detect motion of an infrared emitting source, usually a human body. Infrared radiation is invisible to the human eye but can be detected by electronic devices designed for such a purpose. The term “passive” in this instance means the PIR does not emit energy of any type but merely sits ‘passive’ accepting infrared energy.

Conventional light fixtures with motion sensors are available for serving as light sources in a variety of areas, such as passageways, streets, parking lots, and gardens, and are energy-efficient and permit their attached luminaries to have longer lifetimes than conventional lighting because they function only when they are activated by an infrared source. Passive infrared sensors have been utilized in various motion-sensing devices, such as light fixtures, to sense the motion or presence of a person.

Motion sensors have not yet been incorporated into posts, but instead have been situated outside of the fixtures in a prominent manner. Most of these fixtures have a lamp, a post, and a motion sensor mounted on the outside of the post. This conspicuous positioning of the motion sensor leads to easier detection and avoidance by intruders and is also quite unattractive.

### SUMMARY OF THE INVENTION

Therefore, it is an object of the invention to provide a lighting fixture in which a motion sensor is completely incorporated.

It is still a further object of the invention to provide a lighting fixture including a lamp and a support post with a contained motion sensor that can be integrated in an aesthetically pleasing manner.

Specifically, the invention provides a lighting fixture having a sensor-containing device comprising a protective assembly and an internal assembly, including a motion sensor. The protective assembly keeps the fragile electronic components from being damaged, and it comprises an enclosure and a housing structure. In one embodiment, the housing structure has a left housing piece and a right housing piece that can be fastened together and covered by the enclosure, thereby providing two layers of protection (i.e., the enclosure and the housing structure) for the more fragile components of the internal assembly. The housing structure may also be formed as a unitary part, which eliminates the need to fasten separate parts together.

The internal assembly is situated completely within the protective assembly. The internal assembly comprises an electronic assembly and a plurality of fresnel lenses. The electronic assembly contains a motion sensor, preferably a passive infrared (PIR) motion sensor that can detect motion within a reasonable distance by sensing infrared rays focused on it by the fresnel lenses. The fresnel lenses are situated between the electronic assembly and the left housing and right housing of the protective assembly, respectively, such that they collect radiation from all sides and provide the PIR motion sensor with a “coverage angle” greater than 180 degrees and up to 360 degrees. The PIR motion sensor is able to collect radiation from both large and small distances due to the use of a reflector positioned below the PIR. Due to the design of the fixture, the reflector reflects infrared rays from long distances onto the PIR, whereas infrared rays from shorter distances are focused directly onto the PIR by the fresnel lenses. Without the reflector, the “viewing angle” of the PIR through the fresnel lenses is the area between 50 and 70 degrees measured from the longitudinal axis extending straight down from the PIR. Infrared light in the area between 0 and 50 degrees is blocked by the bottom of the housing piece, and infrared light from the area between 70 and 90 degrees comes through the fresnel lenses but cannot normally be focused onto the PIR. With the reflector, the “viewing angle” increases to cover the area between 50 and 80 degrees.

### BRIEF DESCRIPTION OF THE DRAWINGS

The aspects and advantages of the present invention will be better understood when the detailed description of the preferred embodiment is taken in conjunction with the accompanying drawings, in which:

FIG. 1 is a front view of one embodiment of the lighting fixture mounted on a post;

FIGS. 2a and 2b are respectively a front view and a bottom perspective view of the lighting fixture mounted on a support post;

FIGS. 3a and 3b are respectively front and bottom perspective views of the fixture on a pedestal mount;

FIG. 4 is an exploded front perspective view of the light fixture, a pedestal cover, and a pedestal;

FIGS. 5a and 5b are front perspective views of a luminaire on top of the light fixture mounted on a pedestal and post, respectively;

FIG. 6 is a comprehensive exploded perspective view of the light fixture; and

FIG. 7 is a view of the reflector as it reflects infrared reflection.

### DETAILED DESCRIPTION

While this invention is capable of embodiments in many different forms, the preferred embodiments are shown in the figures and will be herein described in detail. The present disclosure is to be considered an exemplification of the principles of the invention and is not intended to limit the broad aspects of the invention to the embodiments illustrated.

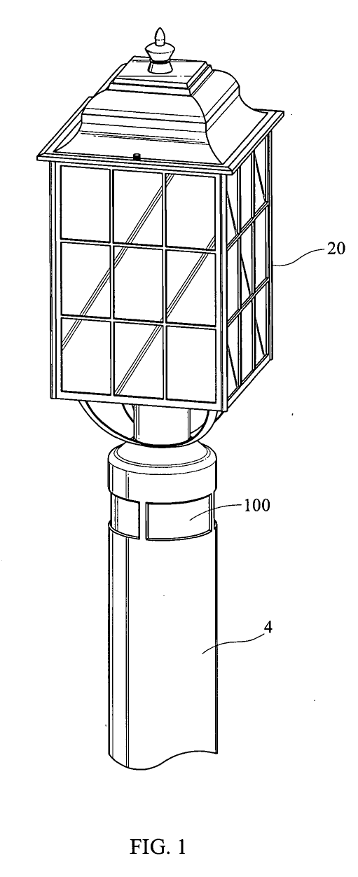

Referring now to the drawings and initially to FIG. 1, in a first embodiment of the present invention, a motion sensing lighting fixture comprises a lighting fixture 20 mounted on a post 4 containing a PIR motion sensor. In this embodiment, the post 4 contains one or more post windows 100 that allow infrared radiation to pass through to the PIR sensor. The windows 100 allow radiation from a large area to reach the PIR sensor so that it can sense movement in greater than 180 degrees. At optimum performance, the sensor can detect motion in all directions, i.e., up to 360 degrees. Put another way, the “coverage angle” of the PIR sensor is greater than 180 degrees, and it is preferably 360 degrees.

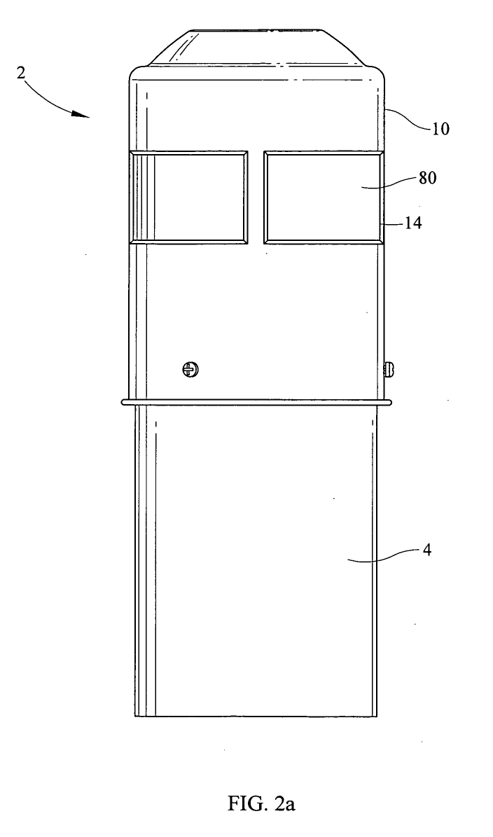

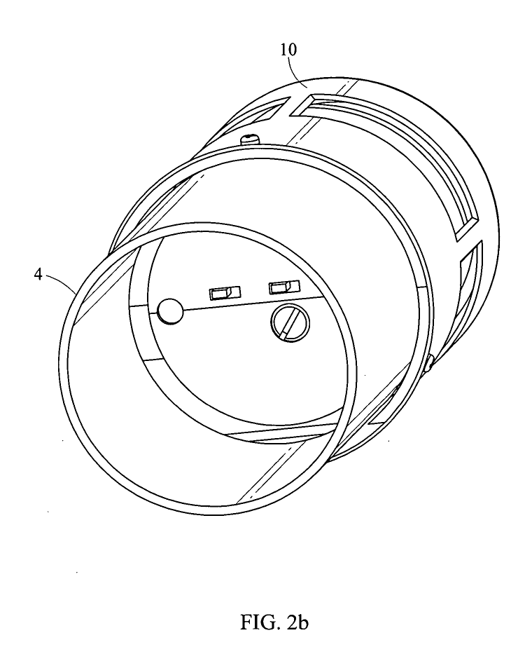

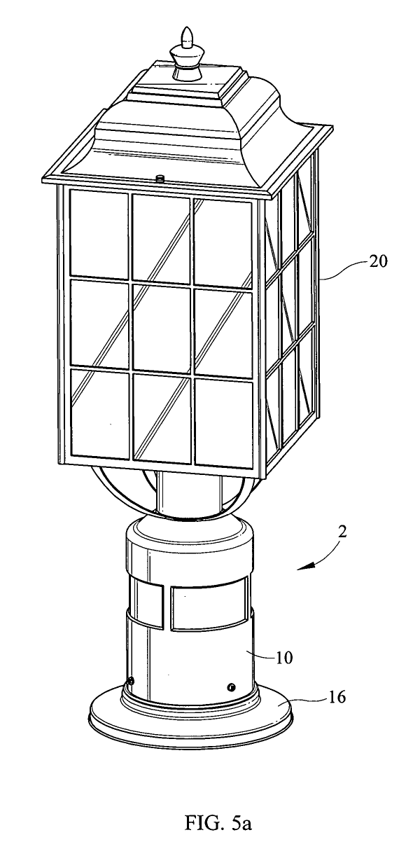

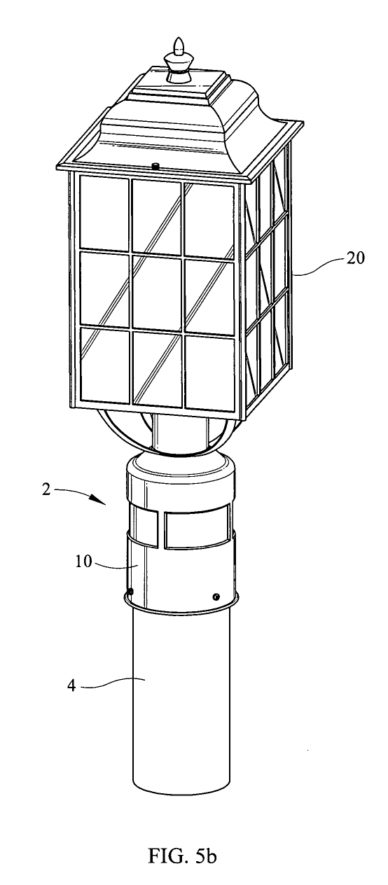

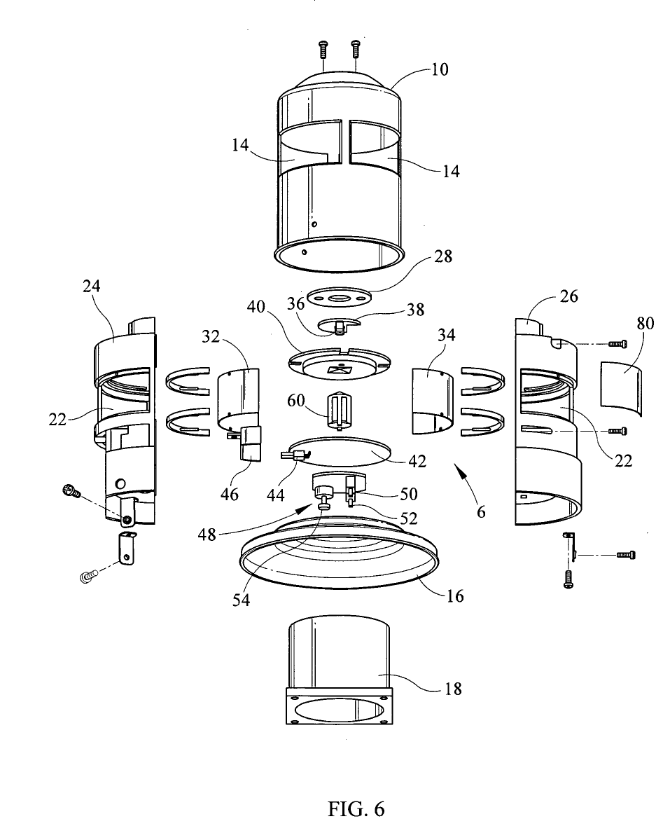

In another embodiment, the lighting fixture can be retrofitted onto a light post that has already been installed. Referring now to FIGS. 2a, 2b, and 6, a sensor-containing support device 2 housing a motion sensor 36 with greater than 180-degree motion sensing capabilities in accordance with one embodiment of the present invention slidably connects over the top of the post 4 or within the post 4 if the post 4 is hollow, but the support device 2 can also simply be mounted on top of the post 4 or attached in another way. The sensor-containing support device 2 comprises an internal assembly 6 and a protective assembly comprising one or more protective coverings that prevent the motion sensor from being harmed. In one embodiment, the protective assembly comprises an enclosure 10 having one or more lens shields 80, and a two part housing structure 24 and 26. The internal assembly 6 is situated completely within the housing structure 24, 26, as shown in FIG. 5. The internal assembly 6 contains PIR motion sensor 36 and other fragile components that will be described in more detail below.

The enclosure 10 seen in FIGS. 2-6 is a cylindrical covering that slides over the housing 24, 26 after the rest of the device has been assembled. The enclosure 10 serves as the first line of defense against the harmful effects of weather or vandalism, whereas the housing 24, 26 is situated completely within the enclosure 10 between the enclosure 10 and the internal assembly 6 of the device. The housing 24, 26 protects the device in case the enclosure is damaged or otherwise becomes unable to protect the device.

The one or more lens shields 80 cover enclosure windows 14 through which infrared radiation passes to the internal assembly 6, which is shown in more detail in FIG. 6. Lens shields 80 act as filters that can be used to customize coverage area by screening or blocking radiation coming from particular angles.

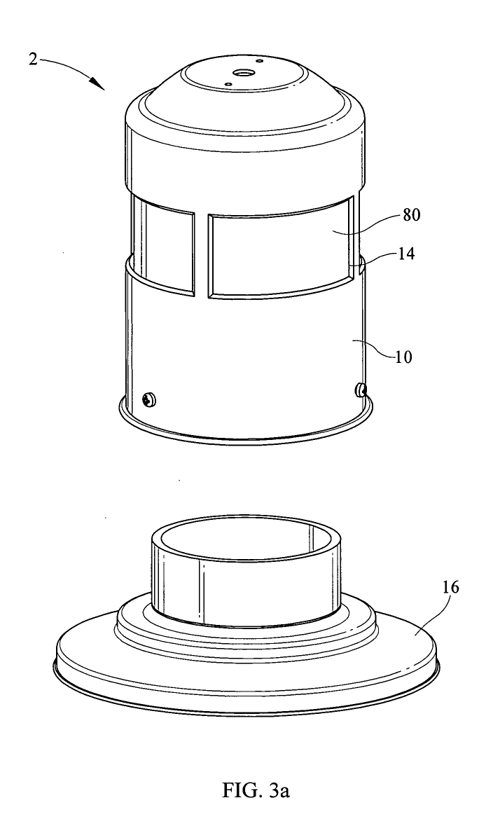

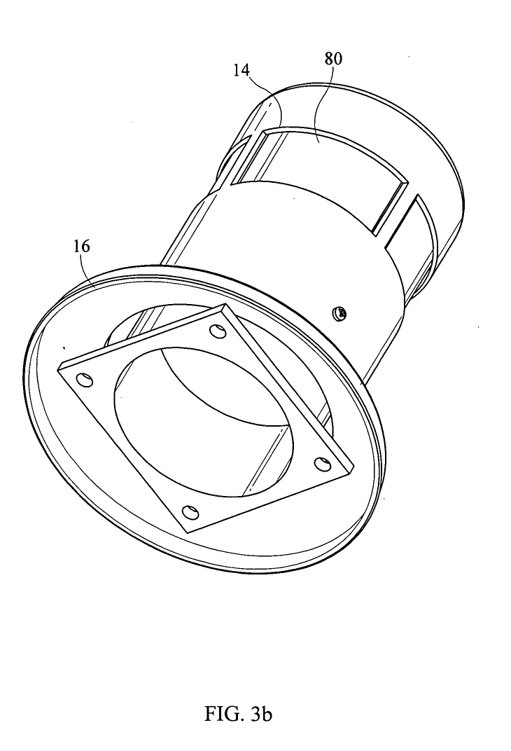

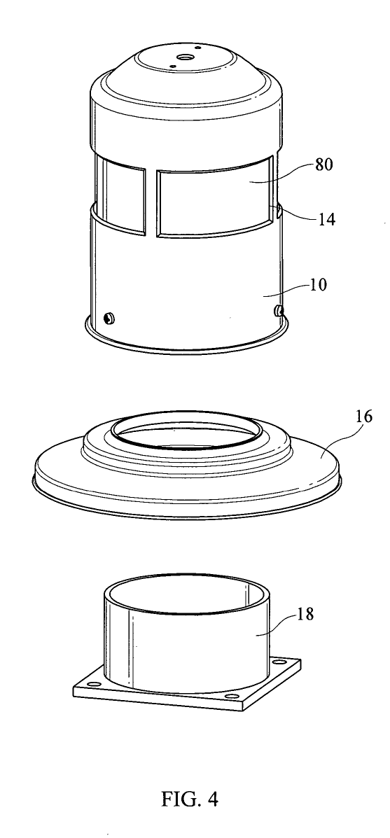

In the embodiment of the invention shown in FIG. 2a, the sensor-containing support device 2 of the invention can be completely integrated with a support post 4. In the past, motion sensors had to be placed on the outside of a post or other support structure, and they were very conspicuous. In contrast, the sensor-containing support device 2 of the invention is less visible and much more aesthetically pleasing. The housing structure 24, 26 and enclosure 10 (FIG. 6) can be matched in color with the support post 4 so that they are attractively and seamlessly integrated. In the embodiment depicted in FIGS. 2a and 2b, the sensor-containing support device 2 is integrated with a post 4, and an enclosure 10 and enclosure windows 14 are the only visible parts of the sensor-containing support device 2. This allows the motion sensor 36 to be integrated with the post in an aesthetically pleasing manner. In another embodiment of the invention shown in FIGS. 3a and 3b, the protective assembly further comprises a pedestal cover 16, which mounts sensor-containing support device 2 on a pedestal 18 instead of a post in an aesthetically pleasing way. An exploded view of fixture 20, pedestal cover 16 and pedestal 18 is shown in FIG. 4.

In order for motion sensor 36 to perform optimally, sensor-containing support device 2 is preferably positioned such that motion sensor 36 is between four and seven feet off the ground. If motion sensor 36 is more than seven feet off the ground, it may not be able to sense motion that is close to the ground and near sensor-containing support device 2. Alternatively, if the motion sensor 36 is less than four feet off the ground, its viewing area may become focused to a point that it is ineffective in sensing motion a reasonable distance away.

FIGS. 5a and 5b show the sensor-containing support device 2 on a pedestal 18 and a post 4, respectively, with a lighting fixture 20 mounted atop it. As shown in these figures, enclosure 10 of sensor-containing support device 2 integrates with the post 4 or pedestal 18 and lighting fixture 20 so that the overall effect is aesthetically pleasing. In the prior art, the motion sensor apparatus was not integrated with either a post or a pedestal, but was separately attached. Accordingly, the motion sensor apparatus was much more prominent. Having a prominent motion sensor is not only unsightly, but it also alerts intruders to the need to avoid detection.

The entirety of sensor-containing support device 2 is shown in FIG. 6 in great detail. The lighting fixture 20 generally comprises an internal assembly 6 situated completely within a protective assembly formed of enclosure 10, one or more lens shields 80, and a two part housing structure 24 and 26. The protective assembly protects the more fragile electronic components of the internal assembly 6 from the effects of weather, vandalism, and other deleterious phenomena. Among other things, the internal assembly 6 comprises a motion sensor 36 upon which the outside infrared radiation is focused. In one embodiment, the motion sensor 36 is a passive infrared (PIR) motion sensor.

The enclosure 10 covers the internal assembly 6, and the housing structure 24 and 26 is attached to enclosure 10. The enclosure 10 is preferably made of brass, but it can be made of a variety of durable, aesthetically attractive materials. The housing structure 24, 26 also contains housing windows 22 through which infrared radiation passes to the internal assembly 6.

The housing structure preferably comprises a left housing piece 24 and a right housing piece 26 that are mirror images of each other. The two housing pieces 24, 26 are joined together, typically by screws or other fasteners, after the internal components of the sensor-containing support device 2 have been assembled. The enclosure 10 is mounted on top of the housing structure so that the enclosure windows 14 and the housing windows 22 align to ensure proper functioning of the enclosed motion sensor 36.

The internal assembly 6 preferably comprises a support washer 28, an electronic assembly described more fully below, and a left fresnel lens 32 and a right fresnel lens 34. The support washer 28 is directly above the electronic assembly and directly below the top of the enclosure 10. The left fresnel lens 32 and the right fresnel lens 34 are situated between the electronic assembly and the left housing piece 24 and the right housing piece 26, respectively, and they line up with the enclosure windows 14 and housing windows 22 so that they can refract infrared radiation from all directions toward a PIR motion sensor 36. The fresnel lenses 32, 34, maximize the amount of light that can be focused on the sensor 36 while taking up very little space.

One or more lens shields 80 can be used to cover the housing windows 22 through which infrared radiation passes to the internal assembly 6, and the lens shields 80 may act as a filter that can be used to customize the field of view of the sensor 36 by screening or blocking radiation coming from selected angles.

The PIR motion sensor 36 is downward-facing, which allows the sensor 36 to detect infrared radiation in all directions. The PIR sensor 36 may be any suitable sensor, such as, for example, Model RE200B from Nippon Ceramic Co., Ltd., and Model LHi 778 from Perkin Elmer Optoelectronics. In prior motion-detecting light fixtures, the PIR motion sensor and accompanying lens or lenses were sideways-facing and faced in only one direction, thereby limiting the area that could be surveyed by the detector to less than 180 degrees. Accordingly, in prior sensors, the area on the side of the fixtures opposite the side faced by the sensor went unobserved, which makes them most effective when placed against a wall or other support facing an area to be observed. In contrast, the sensor 36 of the present invention allows the user to place the fixtures in open spaces away from walls and permits coverage of over 180 degrees and up to 360 degrees by a single motion detector.

In the preferred embodiment, the PIR motion sensor 36 of the electronic assembly is attached to a sensor printed circuit board 38, and a PIR partition 40 is situated below the motion sensor 36. The PIR partition 40 has a central opening through which the PIR motion sensor 36 protrudes.

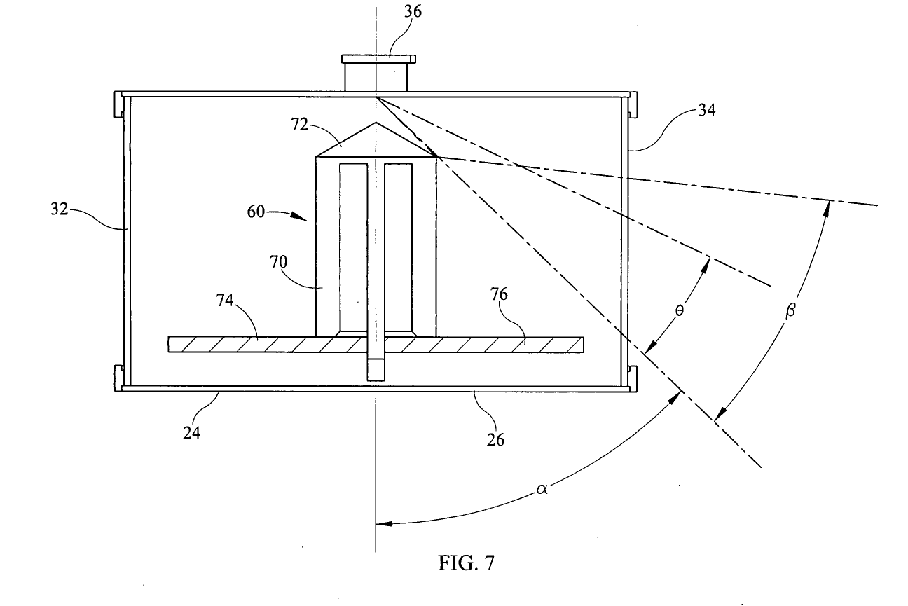

A reflector 60 is also situated below the PIR motion sensor 36, as can also be seen in FIG. 7. The PIR motion sensor 36 is able to collect radiation from both large and small distances due to the use of reflector 60. As shown in FIG. 6, the reflector 60 reflects infrared rays from long distances onto the motion sensor 36, whereas infrared rays from shorter distances are focused directly onto the motion sensor 36 by the fresnel lenses 32, 34. In one embodiment, the use of the reflector 60 increases the distance that can be covered by the sensor 36 from 20 to 30 feet in all directions.

Most PIRs have a maximum “viewing angle” of 120 to 140 degrees. In the lighting fixture described herein, the viewing angle is less than 120 degrees because the 0-50 degree zone α of FIG. 7 is blocked by the housing pieces 24, 26; infrared light from this area cannot be detected by the motion sensor. The fresnel lenses 32, 34 allow light in starting at 50 degrees from the longitudinal axis L. The sensor 36 will collect radiation from the area θ between 50 and 70 degrees directly, and the addition of the reflector extends the total viewing angle β of the motion sensor from between 50 to about 85 degrees. The “coverage angle”—the area around the light fixture in which motion can be detected—is not affected by the addition of the reflector, and in the preferred embodiment, it is 360 degrees. That is, the addition of the reflector increases the distance from the PIR in which light can be detected from about 20 feet to about 30 feet, but it does not affect the coverage angle.

In one embodiment of the invention, the reflector 60 is bullet-shaped, and it has a cylindrical base 70 and a conical top 72. In one embodiment, the cylindrical base 70 has a diameter of 16 mm and a length of 24.5 mm. In this embodiment, the conical top 72 has a height of 4.62 mm. The reflector 60 is supported and maintained in place within the housing by horizontal steps 74, 76 on opposite sides of longitudinal axis L.

In the preferred embodiment of the invention, the reflector is made of acrylonitrile butadiene styrene (ABS) plastic that is covered by an aluminum coating. In other embodiments, the reflector is made entirely of aluminum or stainless steel.

A main printed circuit board 42, or “motherboard,” is also positioned below the PIR partition 40. The main printed circuit board 42 in the electronic assembly of the invention, as in other electronic assemblies, is the location where the various electrical components converge and communicate with each other. The PIR partition 40 separates the sensor printed circuit board 38 from the main printed circuit board 42.

Several components are attached to the main printed circuit board 42, including a triac 44 and a triac heat sink 46. Also attached to the main printed circuit board 42 is a switchboard 48. The switchboard 48 contains an on-timer switch 50, a dual-brite timer switch 52, and a range adjusting potentiometer 54. The on-timer switch 50 and the dual-brite timer switch 52 serve different functions, but both greatly enhance the operation of the sensor-containing support device 2. The dual-brite switch 52 controls a dual-brite timer, which is a feature that allows the light fixture 20 to provide low-level accent lighting at approximately 50% brightness until motion is detected. When motion is detected, the light fixture 20 increases to full brightness until the on-time setting expires. The dual-brite feature can be set to various time intervals beginning at dusk and continuing for three hours, six hours, or until dawn. This feature, however, can be turned off, in which case the luminaire will function as a motion light only. The on-timer resets each time motion is detected. Consequently, if the motion reoccurs before the time elapses, the luminaire will remain on at full brightness. The motion sensor 36 detects the movement of heat, so heating or cooling units, dryer vents, swimming pools, and other objects that radiate heat can also activate the motion sensor 36 or keep it activated.

The range adjusting potentiometer 54 determines what level of change in radiant energy will cause the motion sensor 36 to react. In general, the sensitivity of motion sensors can vary depending on weather conditions. Infrared sensors, such as the motion sensor 36 of the current invention, measure changes in ambient temperature. When the sensor 36 detects an increase or decrease in temperature “moving” across its detection zone (e.g., a person walking in front of the unit), it activates the light. It follows that the sensor 36 will be less sensitive to motion when the temperature of the detected object and the detection zone are about the same. The range potentiometer 54 can then be adjusted to be more sensitive to smaller changes in temperature.

While there have been described what are believed to be the preferred embodiments of the present invention, those skilled in the art will recognize that other and further changes and modifications may be made thereto without departing from the spirit of the invention, and it is intended to claim all such changes and modifications as fall within the true scope of the invention.

1. A motion sensing lighting fixture comprising:
a support post;
a light mounted on the support post; and
a passive infrared motion sensor fixedly contained in said support post and adapted to sense infrared radiation over a greater than 180-degree field of view.

2. The lighting fixture of claim 1, wherein said post further comprises at least one window adapted to allow infrared radiation to pass into the interior of said post.

3. The lighting fixture of claim 1 further comprising a sensor-containing support device mounted on top of said support post.

4. The lighting fixture of claim 3, wherein said sensor-containing support device slidably connects to said support post.

5. The lighting fixture of claim 3, wherein said sensor-containing support device comprises one or more protective coverings.

6. The lighting fixture of claim 5, wherein said one or more protective coverings comprise a housing covered by an enclosure.

7. The lighting fixture of claim 6 comprising at least one window in each of said enclosure and said housing that allows infrared radiation to pass through to the interior of said housing.

8. The lighting fixture of claim 7 comprising at least one lens shield situated within said window of said housing.

9. The lighting fixture of claim 8, wherein said at least one lens shield is a fresnel lens.

10. The lighting fixture of claim 1, wherein said motion sensor has a field of view of up to 360-degrees.

11. The lighting fixture of claim 1, wherein said passive infrared motion sensor is mounted so as to face downward.

12. The lighting fixture of claim 1 comprising an on-timer switch situated within said housing.

13. The lighting fixture of claim 1 comprising a second timer switch situated within said housing.

14. The lighting fixture of claim 1 comprising means by which said lighting fixture maintains low-level accent lighting at approximately 50% brightness until motion is detected by said sensor, wherein when motion is detected said light fixture increases to full brightness.

15. The lighting fixture of claim 1 comprising a conical reflector situated within said housing and below said motion sensor.

16. A motion sensing lighting fixture comprising:
a support post;
a sensor-containing support device mounted on said support post, said sensor-containing support device having a housing covered by an enclosure;
at least one window in the housing that allows infrared radiation to pass through to the interior of the housing; and
a passive infrared motion sensor mounted in the interior of the housing and adapted to sense infrared radiation passed through the window over a greater than 180-degree field of view, wherein the passive infrared motion sensor is mounted so as to face downward.

17. The lighting fixture of claim 16, wherein said motion sensor has a field of view of up to 360-degrees.

18. The lighting fixture of claim 16 comprising at least one lens shield situated within said window so as to allow the field of view of the sensor to be a selected point between 180 and 360-degrees.

19. The lighting fixture of claim 16 comprising a conical reflector situated within said housing and below said motion sensor.

20. A motion sensing lighting fixture mounted on a support post and having a wide motion sensing field of view, comprising:
a light fixture mounted on said support post having a housing surrounding a lamp, said lamp in electrical communication with a power source;
a PIR sensor suspended within said support post;
a reflector mounted below said PIR sensor, said reflector surrounded by a lens and having a field of view greater than 190 degrees.

21. The motion sensing lighting fixture of claim 20 wherein said reflector is centrally positioned below said sensor.

22. The motion sensing lighting fixture of claim 20 wherein said reflector is an inverted cone below said sensor.

23. The motion sensing lighting fixture of claim 20 wherein said inverted cone reflector is supported on a reflector support structure below said sensor.

24. The motion sensing lighting fixture of claim 20 wherein said reflector reflects heat to said sensor through said lens from a field of view of greater than about 200 degrees but less than or equal to about 360 degrees.

25. A post top motion light having a wide area field of view comprising:
a lamp in electrical connection to a control and power supply circuit;
a motion sensor housing below said lamp;
a motion sensor suspended within said motion sensor housing and having a downward field of view;
a reflector mounted in said motion sensor housing and below said suspended motion sensor;
wherein said reflector is surrounded by a lens and collimates radiation through said lens and upwards toward said motion sensor.

26. The post top motion light of claim 25 wherein said reflector is an inverted cone shaped reflector.

27. The post top motion light of claim 25 wherein said inverted cone shaped reflector is supported by a stand directly below said motion sensor.

28. The post top motion light of claim 25 wherein said reflector collimates radiation from a field of view greater than about 185 degrees.

29. A motion sensing lighting fixture comprising:
a support post;
a light mounted on the support post; and
a passive infrared motion sensor fixedly contained in said support post and adapted to sense infrared radiation.
